(19) United States
(12) Patent Application Publication
(10) Pub. No.: US 2004/0136405 A1
(43) Pub. Date: Jul. 15, 2004

(54) Obtaining and maintaining TTR synchronization during DSL transceiver channel discovery phase in presence of TCM-ISDN noise

(76) Inventors: Guozhu Long, Fremont, CA (US); Sanjay Gupta, Union City, CA (US); Guojie Dong, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/713,589

(22) Filed: Nov. 13, 2003

Related U.S. Application Data
(60) Provisional application No. 60/426,605, filed on Nov. 14, 2002.

(51) Int. Cl. H04J 3/06

(52) U.S. Cl. 370/503

(57) ABSTRACT

Techniques are disclosed for obtaining and maintaining synchronization of the TTR clock during a Channel Discovery Phase of DSL transceiver initialization for a DSL service operating in a TCM-ISDN crosstalk environment. The customer premises DSL transceiver achieves synchronization of its TTR clock throughout the Channel Discovery Phase of the DSL initialization procedure using a TTR indication signal transmitted by the central office transceiver. In addition to enabling basic communications, keeping TTR synchronization improves the accuracy of quiet noise measurement and the reliability of message exchanges, even on very long and noisy loops.

### CROSS REFERENCE TO RELATED APPLICATIONS

This application claims the benefit of U.S. Provisional Application No. 60/426,605, filed Nov. 14, 2002, which is hereby incorporated in its entirety by reference.

### BACKGROUND

1. Field of the Invention

This invention relates generally to DSL service operating in a TCM-ISDN crosstalk environment, and in particular to obtaining and maintaining synchronization of the TTR clock during a Channel Discovery Phase of DSL transceiver initialization.

2. Background of the Invention

Under certain operating conditions, Digital Subscriber Line (DSL) transmissions can be affected by crosstalk interference from other services bundled within a common cable binder. The level of crosstalk generated by other services varies for different cable structures and materials. Some countries, such as Japan and Korea, use telephone cables with a paper-based “pulp” insulator rather than the plastic insulated cables (PIC) used in the United States. These pulp cables have poor insulation and thus cause a high level of crosstalk between different services over copper wires bundled in the same cable binder. Integrated Services Digital Network (ISDN) service is especially troublesome when combined with DSL service because portions of the transmission band for ISDN service overlap portions of the transmission band for DSL service. Like DSL service, ISDN service is deployed widely over copper wires and bundled in the same cable binders as the wires used in DSL service. Because the transmission bands for ISDN and DSL services overlap, ISDN service can cause crosstalk in and interfere with DSL services.

To address this problem where the noisy pulp cables are installed, a special system was developed, described in the International Telecommunication Union Telecommunication Standardization Sector (ITU-T) specification G.961 Appendix III. The G.961 Appendix III system reduces crosstalk interference by switch synchronizing ISDN cards at the central office using Time Compression Multiplexing (TCM). TCM provides for ISDN signal transmission and reception during different time periods to reduce near-end crosstalk between ISDN services. ITU-T ADSL standards G.992.1 Annex C and G.992.2 Annex C describe the operation of DSL modems under TCM-ISDN interference. Signal transmissions from DSL modems are switch synchronized to a 400-Hz TCM Timing Reference (TTR) generated at the central office. The TTR signal is the master clock signal for determining when the central office (CO) modem and the customer premises equipment (CPE) modem should transmit and receive ISDN and DSL signals. FIG. 1 is a diagram of the CO modem 12 (ATU-C) at the CO 10 in communication with the CPE modem 22 (ATU-R) at the CPE 20. Downstream is defined from the ATU-C 12 to the ATU-R 22.

Within a particular cable binder, the TCM-ISDN system generates a time varying noise environment. During the first half period of the TTR signal, the ATU-C 12 is dominated by near-end crosstalk (NEXT) interference, and during the second half by far-end crosstalk (FEXT) interference. The reverse is true for the ATU-R 22. Because FEXT interference is much weaker than NEXT interference and smaller relative to the received signal, the signal-to-noise ratio (SNR) in the presence of FEXT is higher than in NEXT. This results in a higher channel capacity during FEXT periods. For optimal performance, therefore, each modem trains itself for both types of interference and switches between these training settings according to the TTR signal.

FIG. 2 is a timing diagram for a TCM-ISDN system illustrating the relationship between the TTR signals, the ISDN transmit and receive channels, and the NEXT and FEXT interference for each modem. The TCM-ISDN system transmits ISDN in alternating directions as described by the TTR signal. This causes the modems to experience alternating and generally opposite NEXT and FEXT interference, as illustrated. FIG. 3 shows the relationship between the ATU-C's TTR signal (TTR_{C}), the interference at the ATU-R 22 (NEXT_{R} and FEXT_{R}), and the frames transmitted by the ATU-C 12. A “sliding window” operation defines the procedure for transmitting symbols under ISDN interference synchronized to the TTR signal. The FEXT_{R} symbols are symbols completely inside the FEXT_{R} period, and the NEXT_{R} symbols are symbols inside any portion of the NEXT_{R} period; thus, there are more NEXT_{R} symbols than FEXT_{R} symbols. The ATU-C 12 determines if a particular symbol is a FEXT_{R} symbol or NEXT_{R} symbol according to the sliding window and then transmits the symbol with a corresponding bit table. Conversely, the ATU-R 22 determines if a particular symbol is a FEXT_{C} symbol or NEXT_{C} symbol and transmits the symbol with the appropriate bit table.

As shown in FIG. 4, the TTR signal and the training symbols are not exactly aligned; however, the TTR signal spans either 32 or 34 periods during a period of 345 symbols, depending on the insertion of the cyclic prefix to the symbols. Therefore, this least common multiple period of 345 symbols defines a hyperframe. FIG. 4 shows the 345 training symbols in a hyperframe for downstream without cyclic prefix, and their relationship to the TTR signal, including the mapping of symbols to FEXT_{R}/NEXT_{R} channels. The FEXT_{R} training symbols represent data treated as transmitted through the FEXT_{R} channel. The remaining training symbols, including any symbols that are at least partially affected by NEXT interference, are treated as though they were transmitted through the NEXT_{R} channel.

In each of the G.992.1 and G.992.2 standards, Annex A to the standard defines a basic operation of the DSL modem, and Annex C modifies the standard for operation in the presence of TCM-ISDN interference. In Annex C of G.992.1, a TTR indication signal is sent in the C-PILOT1 signal with phase reversals of tone 48. These phase reversals occur at the boundaries of FEXT-NEXT symbol transitions, and the signal is sent along with pilot tone 64. In G.992.1 Annex C, the ATU-C continues to transmit the pilot tone after the C-PILOT1 signal in at least all FEXT_{R} symbols. This allows the ATU-R to maintain TTR synchronization at all times.

The ITU-T standards body has defined a new generation of DSL standards, referred to as G.992.3 or ADSL2. While an Annex A has been defined for G.992.3, an Annex C modifying the standard for operation in a TCM-ISDN environment has not. One important difference between the new G.992.3 standard and its predecessors is the initial training sequence. In G.992.3, the initialization starts with a new “Channel Discovery Phase,” in which the modems perform functions such as coarse timing recovery, channel probing, quiet noise measurement, and power cutback. Also during this phase, the ATU-R identifies a sub-carrier suitable for transmitting the timing reference signal during transceiver training; this sub-carrier is called the pilot tone. Since this pilot tone is selected near the end of the Channel Discovery Phase, it is not available throughout the Channel Discovery Phase. This does not pose a problem in systems where there is no TCM-ISDN crosstalk, since there would be no need for the ATU-R to synchronize to the TTR signal, and a minor timing offset would not cause a serious problem. In systems that operate in a TCM-ISDN crosstalk environment, however, the modems must acquire and maintain synchronization to the TTR before they can perform the operations defined in the Channel Discovery Phase. Therefore, there needs to be developed another method for synchronizing the TTR clock during the Channel Discovery Phase.

In addition, G.992.3 adds the useful new feature of performing loop diagnostics. During the Channel Discovery Phase, the ATU-C and ATU-R each measure the quiet noise level per bin, channel attenuation per bin, and SNR per bin. Because the quiet noise has different levels during the NEXT and FEXT periods, each modem must measure two sets of quiet noise levels and SNR per bin—one for the NEXT period and one for the FEXT period. But before the modems can perform these measurements for NEXT and FEXT periods, the modems must know when these periods occur. This requires that the TTR clocks be synchronized.

In G.992.1 Annex C, the ATU-C continues to transmit the pilot tone in all FEXT_{R} symbols, which allows the ATU-R to maintain TTR synchronization. In G.992.3 Annex A, however, after C-COMB1, there are time periods in which the ATU-C is sending the C-QUIET signal. Due to the absence of a signal from the ATU-C from which the TTR signal or timing signal can be recovered, the ATU-R's TTR clock may drift, causing symbol boundaries to shift. ATU-R clock drift may create several problems. For example, after quiet periods, messages must be transmitted (C-MSG-FMT, C-MSG-PCB, R-MSG-FMT and R-MSG-PCB) during FEXT symbols only. With clock drift, the FEXT symbols can be corrupted by TCM-ISDN NEXT interference, causing message exchange to fail. In addition, extended quiet periods may be used to measure quiet noise levels under FEXT and NEXT separately, and ATU-R clock drift can reduce the accuracy of that quiet noise measurement. Lastly, for operation modes such as FBM, only FEXT symbols are transmitted to avoid NEXT to adjacent lines. With clock drift, some “FEXT” symbols may drift into NEXT periods, corrupting the signal.

For DSL service operating in a TCM-ISDN crosstalk environment, therefore, it is important for the ATU-R to synchronize its TTR clock and maintain that synchronization during the Channel Discovery Phase so it can perform the functions defined in that phase. It is also important for the ATU-R to avoid TTR clock drift during quiet periods in the Channel Discovery Phase. It is further desirable to provide a robust TTR indication signal that allows the ATU-R to detect a TTR indication signal, even on long and noisy loops.

### SUMMARY OF THE INVENTION

The present invention enables the customer premises transceiver to synchronize its TTR clock and maintain synchronization of that clock throughout the Channel Discovery Phase of the DSL initialization procedure. In addition to enabling basic communications, keeping TTR synchronization improves the accuracy of quiet noise measurement and the reliability of message exchanges, even on very long and noisy loops.

An appropriate TTR indication signal is defined to allow the customer premises (CPE) DSL transceiver to detect the TTR signal and synchronize its TTR clock thereto. In one embodiment, the central office (CO) DSL transceiver transmits the TTR indication signal to the CPE transceiver during the Channel Discovery Phase of a DSL service initialization operating in a TCM-ISDN noise environment. Using this TTR indication signal, the CPE transceiver synchronizes its TTR clock, thereby enabling Channel Discovery Phase functions such as coarse timing recovery, channel probing, quiet noise measurement, power cutback, and messaging between the CO and the CPE transceivers and the customer premises DSL transceiver.

To maintain TTR synchronization during quiet periods in the Channel Discovery Phase, the ATU-C transmits a TTR indication signal to the ATU-R that allows the transceiver to maintain synchronization of its TTR clock. In one embodiment, the TTR indication signal is defined as C-COMB1 in the first four FEXT_{R} symbols of a hyperframe and no signal (C-QUIET) in the other symbols. In another embodiment, the TTR indication signal includes a REVERB signal.

In another embodiment, TTR synchronization is maintained while the CO and CPE transceivers perform quiet noise measurements. To maintain TTR synchronization during long periods in which the CO transceiver would otherwise not transmit any signals, the CO modem is configured to transmit a TTR indication signal during a portion of the hyperframes transmitted during a quiet period. This avoids drift of the CPE transceiver's TTR clock during quite periods. In addition, the CO transceiver may transmit a TTR indication signal during the FEXT_{R} periods while the CPE transceiver is transmitting messages to the CO transceiver, as defined in the Channel Discovery Phase. This TTR indication signal allows the CPE transceiver to maintain TTR synchronization during transceiver messaging, thereby avoiding TTR drift that can corrupt such messaging during the Channel Discovery Phase.

### BRIEF DESCRIPTION OF THE DRAWINGS

FIG. 1 is a diagram of the CO and CPE modems.

FIG. 2 is a diagram illustrating the timing relationship among the TTR signals, the ISDN transmit and receive channels, and NEXT and FEXT interference.

FIG. 3 is a diagram illustrating the timing relationship among the TTR signal, ISDN NEXT/FEXT interference, and the ATU-C transmit frames.

FIG. 4 is a diagram illustrating the timing relationship between a hyperframe, the symbols in a hyperframe, and the TTR signal.

FIG. 5 is a timing diagram of a modified Channel Discovery Phase of the initialization procedure for G.992.3.

FIG. 6 is a timing diagram of one embodiment of the TTR indication signal, showing the TTR indication signal and a portion of the hyperframe in which it is transmitted.

FIG. 7 is a timing diagram of the Channel Discovery Phase of the initialization procedure in accordance with another embodiment of the invention.

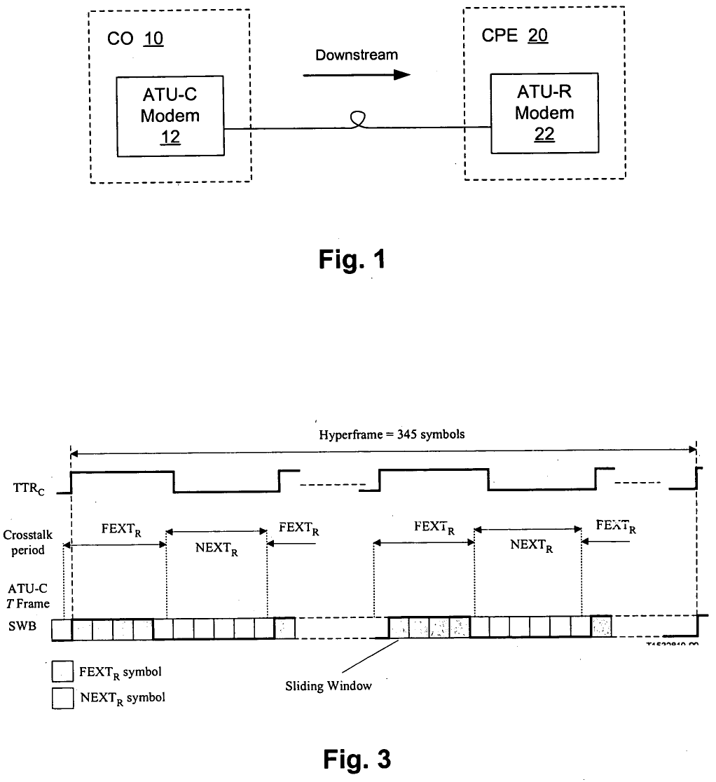

### DETAILED DESCRIPTION OF THE PREFERRED EMBODIMENTS

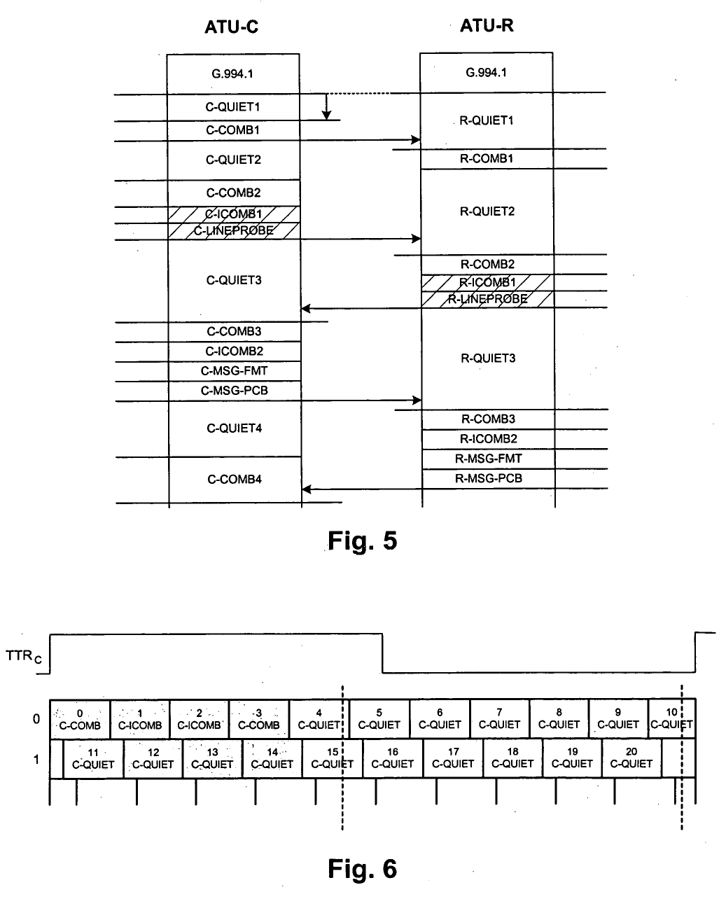

FIG. 5 is a timing diagram of a modified Channel Discovery Phase of the initialization procedure provided in G.992.3 Annex A. This timing diagram shows the signals transmitted by the ATU-C and the ATU-R and their relative timing, measured in symbols. The ATU-C and ATU-R begin communication by performing a handshaking session, as defined in the G.994.1 standard. Once the handshaking session is complete, the modems enter a first quiet mode (C-QUIET1 and R-QUIET1) during which the modems do not transmit. When at least one of the modems is in a quiet mode, the other can perform some loop diagnostics functions, such as measuring the quiet noise level per bin. After a defined period of time, the ATU-C begins to transmit a C-COMB1 signal, which allows the ATU-R to perform coarse timing recovery and other functions defined in the Channel Discovery Phase. Throughout this phase the ATU-C and ATU-R change states from being in quiet mode to transmitting COMB signals or other messages (e.g., MSG-FMT and MSG-PCB), as shown in FIG. 5.

As described above, the Channel Discovery Phase described in G.992.3 Annex A must be modified for Annex C, in which the DSL service operates in a TCM-ISDN crosstalk environment. Accordingly, in an embodiment of the invention, the procedure described for G.992.3 Annex A is modified as follows to obtain and maintain TTR synchronization in the ATU-R.

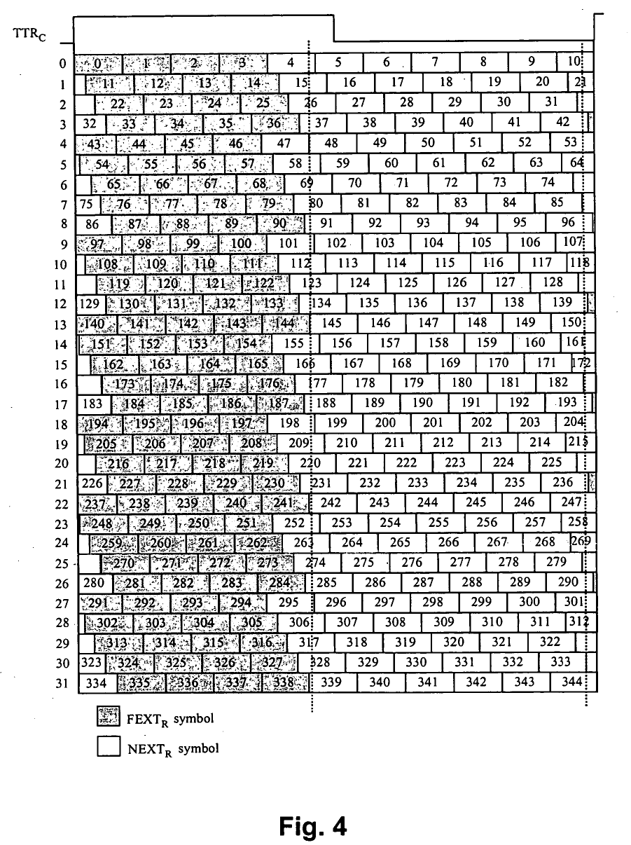

In one embodiment, a C-COMB symbol is defined as a wideband multi-tone symbol that contains a number of spaced-apart sub-carriers, such as the 16 sub-carriers with indices 11, 23, 35, 47, 59, 64, 71, 83, 95, 107, 119, 143, 179, 203, 227, and 251. The C-COMB1 signal includes a C-COMB symbol in the first and the last symbol of each group of consecutive FEXT_{R} symbols, and C-ICOMB (an inverted C-COMB symbol) in the other FEXT_{R} symbols. For example, referring to the hyperframe structure shown in FIG. 4, symbols 0 through 3 are the first group of consecutive FEXT_{R} symbols in the hyperframe. Symbols 0 and 3 are the first and last in the group, so the C-COMB signal is transmitted for them. For the other symbols, symbols 1 and 2, the C-ICOMB is transmitted. In some cases, such as for symbols 140 through 144, there are five consecutive FEXT_{R} symbols. In such a case, the C-COMB signal is transmitted for symbols 140 and 144, and the C-ICOMB signal is transmitted for the three interior symbols 141, 142, and 143.

In one embodiment, a TTR indication signal is defined as C-COMB1 in the first four FEXT_{R} symbols of a hyperframe and no signal (C-QUIET) in the other symbols. FIG. 6 illustrates this embodiment of the TTR indication signal, showing the first portion of a hyperframe in which the TTR indication signal is transmitted. The symbols not shown in this hyperframe are all C-QUIET. It can be appreciated that this TTR indication signal begins at the boundary of each hyperframe. By detecting the TTR indication signal, therefore, the ATU-R can detect the boundaries of the hyperframe and thereby synchronize its TTR clock.

In one embodiment, the ATU-C transmits this TTR indication signal during the C-QUIET2 signal shown in FIG. 5. Accordingly, the ATU-R can maintain TTR synchronization during this “quiet” mode. Moreover, the TTR indication signal allows for the other 341 symbols of the hyperframe to be C-QUIET. Since both the ATU-C and ATU-R know when the C-COMB burst will occur in the TTR indication signal (i.e., the first four symbols), they can skip over those symbols of each hyperframe and perform quiet noise measurements during the other symbols. The ATU-C may also transmit the TTR indication signal during other quiet periods, as needed for maintaining TTR synchronization.

One issue for G.992.3 Annex C is how to measure the quiet noise. In G.992.3 Annex A, quiet noise can be measured during QUIET1. In G.992.3 Annex C, however, the ATU-R must synchronize to the TTR clock before measuring quiet noise and maintain synchronization during the measurement. Quiet noise measurements must be performed for both NEXT and FEXT periods, and when these periods occur requires knowledge of the TTR. Therefore, the ATU-R cannot perform quiet noise measurements during that period because the TTR clock is not synchronized until after the C-QUIET1 signal (specifically, during C-COMB1). Accordingly, the G.992.3 Annex A is modified for Annex C to perform quiet line noise measurements during the C-QUIET2 signal rather than during the C-QUIET1 signal. To allow sufficient time to measure quiet line noise for both FEXT and NEXT periods, the C-QUIET2 and R-QUIET2 signals are extended. But with the resulting longer quiet periods (e.g., around 2 seconds), the TTR clock obtained in the C-COMB1 symbol can drift due to lack of a pilot tone. This can cause errors in the measurement of quiet noise because the modems may lose track of when the FEXT and NEXT periods occur. Accordingly, transmitting the TTR indication signal during these quiet periods allows the TTR clock to remain synchronized.

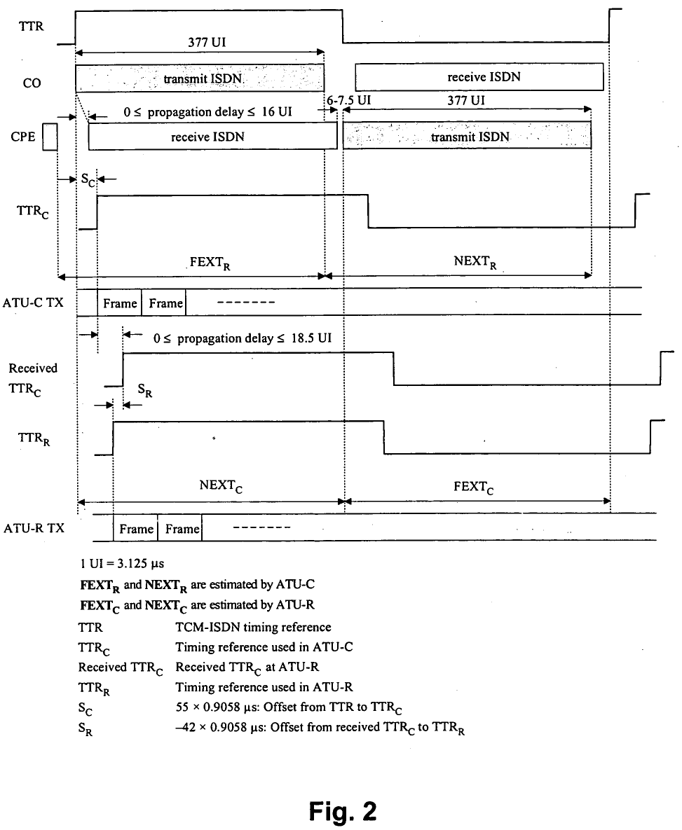

The ATU-R's TTR clock may drift not only during quiet periods, but also in periods in which the ATU-R is transmitting messages to the ATU-C and the ATU-C is quiet. Such period include R-MSG-FMT and R-MSG-PCB. In another embodiment, therefore, the C-QUIET4 signal described in G.992.3 Annex A is replaced with C-QUIET4 and C-COMB4 signals, as illustrated in FIG. 5. The C-COMB4 signal begins after the ATU-C receives all the R-ICOMB2 symbols from the ATU-R. During C-COMB4, the ATU-C transmits the TTR indication signal as described above for the C-QUIET2 signal. Although this signal overlaps with the time in which the ATU-R is transmitting R-MSG-FMT and R-MSG-PCB, there is no conflict between the signals because it is transmitted only in FEXT_{R} symbols. When ATU-C is transmitting the TTR indication signal in FEXT_{R} symbols, the ATU-R is not transmitting because the ATU-R transmits R-MSG-FMT and R-MSG-PCB in FEXT_{C} time only. (FEXT_{R} and FEXT_{C} periods occur at different times, as illustrated in FIG. 2.) Transmitting the TTR indication signal during C-COMB4 allows the ATU-R to resynchronize its TTR clock continuously, thus avoiding TTR clock drift.

Although the C-COMB signal can be used for timing recovery, other types of signals having better correlation properties may be used in the TTR indication signal. The multi-tone C-C-COMB signal was intended for regular functions of the Channel Discovery Phase, such as coarse timing recovery, channel probing, and power cutback. As such, it is not optimized for TTR synchronization. Because of its poor correlation properties, the boundaries and phase reversals of the C-COMB signal may be difficult for the ATU-R to detect. This effect is more pronounced on long loops where the high-frequency tones are attenuated, which can result in unreliable detection of and synchronization to the TTR signal.

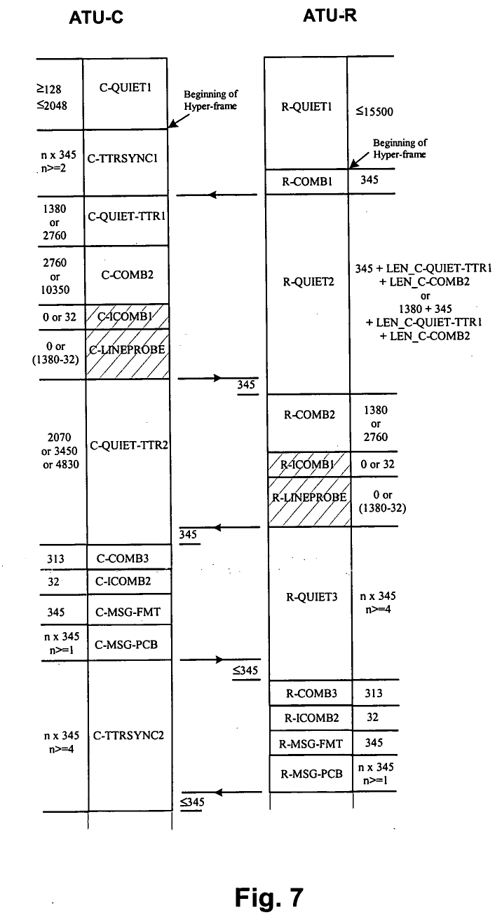

To address this problem, a dedicated signal C-TTRSYNC1 is defined independent of C-COMB. FIG. 7 shows a timing diagram of the Channel Discovery Phase in accordance with another embodiment of the invention. In the process shown in FIG. 7, the ATU-C transmits a TTR indication signal that has better correlation properties and thus gives a more reliable indication signal than the C-COMB signal. In one embodiment, the TTR indication signal includes a REVERB signal, which has good correlation properties and thus is easy to detect, even on very long and noisy loops. Moreover, since a REVERB detector is common in ADSL modems, its implementation is very convenient.

In one embodiment, the C-TTRSYNC1 is a C-REVERB signal in each of a consecutive series of sub-carriers. For example, the C-TTRSYNC1 can be defined to be C-REVERB33-64, which includes sub-carriers 33 through 64 of C-REVERB, transmitted only in the first four symbols of each hyperframe. By transmitting the REVERB signal in only the first four symbols of the hyperframe, this C-TTRSYNC1 signal indicates the beginning of the hyperframe. In all other FEXT_{R} symbols of the hyperframe, only two tones are transmitted (such as tones 48 and 64) to allow the ATU-R to perform coarse pilot tracking. However, no signal is transmitted during NEXT_{R} symbols, thereby allowing the ATU-R to transmit signals during its FEXT_{C} periods.

For longer loops, where the higher frequency tones tend to be attenuated, the TTR indication signal can use lower frequency sub-carriers to avoid attenuation of the TTR indication signal. For example, the C-TTRSYNC1 can be defined to be C-REVERB6-32, which includes the lower frequency sub-carriers 6 through 32 of C-REVERB, transmitted only in the first four symbols of each hyperframe. Again, by transmitting the REVERB signal in only the first four symbols of the hyperframe, this C-TTRSYNC1 signal is used by the ATU-R to detect the beginning of the hyperframe. And because the lower frequency sub-carriers are used, this signal is less likely to be attenuated over longer loops.

The C-TTRSYNC1 has a variable length, for example a multiple of one hyperframe (i.e., 345n symbols, where n≧1). As FIG. 7 shows, the ATU-C continues to transmit C-TTRSYNC1 until the end of the hyperframe during which it receives R-COMB1 from the ATU-R. Because the ATU-C must detect R-COMB1 while transmitting C-TTRSYNC1 in the same frequency band, the pilot tones sent by the ATU-C are transmitted only during FEXT_{R} symbols. This allows the ATU-C to receive the R-COMB1 signal during periods of NEXT_{R}, when the ATU-R is experiencing FEXT_{C} and thus is transmitting the R-COMB1 signal.

In a loop diagnostics mode, the modems perform quiet noise measurement during a modified C-QUIET-TTR1/R-QUIET2 signal, instead of during the C-QUIET1/R-QUIET1 signal defined in G.992.3 Annex A. To perform quiet noise measurement, C-QUIET-TTR1 is set to be sufficiently long to allow the modems to perform the measurements. Because the modems perform quiet noise measurement during this period and not during C-QUIET1/R-QUIET1, the length of C-QUIET1 and R-QUIET1 may be shortened accordingly relative to Annex A. In one embodiment, the length of C-QUIET-TTR1 is 1380 symbols, or four hyperframes. To implement a diagnostics mode, it may be necessary to add four more hyperframes (for a total of 2760 symbols) to C-QUIET-TTR1 to allow quiet noise measurement. Correspondingly, the R-QUIET2 signal may be extended by the same number of symbols. To allow the ATU-R to maintain TTR synchronization, the C-QUIET-TTR1 signal is defined to be the same as C-TTRSYNC1 in the first fours symbols of each hyperframe. The ATU-C transmits no signal in the other FEXT_{R} symbols, allowing for quiet noise measurement during those symbols.

The ATU-C transmits messages to the ATU-R during the C-MSG-FMT and C-MSG-PCB signals, and the ATU-R transmits messages to the ATU-C during the R-MSG-FMT and R-MSG-PCB signals. In each of these signals, each modem only transmits data during its FEXT symbols, not during any NEXT symbols due to the increased interference that would make such transmissions unreliable. Importantly, the FEXT_{C} symbols for the ATU-R do not occur during the FEXT_{R} symbols for the ATU-C (see FIG. 2), so there is no competition between the signals transmitted by each modem. [00381 In addition, the C-QUIET3 and C-QUIET4 signals defined in G.992.3 Annex A are replaced by the C-QUIET-TTR2 and C-QUIET-TTR3 signals, as illustrated in FIG. 7. These C-QUIET-TTR2 and C-QUIET-TTR3 signals are the same as the C-QUIET-TTR1 signal, defined above. The ATU-C transmits the C-QUIET-TTR2 or C-QUIET-TTR3 signal during its FEXT_{R} symbols only, when the ATU-R is not transmitting. The ATU-R transmits the R-COMB2, R-MSG-FMT, and R-MSG-PCB signals in its own FEXT_{C} symbols only, when the ATU-C is not transmitting. Accordingly, the ATU-R can continuously resynchronize its TTR clock using the signals received from the ATU-C, even when the ATU-C and ATU-R are exchanging messages as required by the Channel Discovery Phase.

In Annex A of G.992.3, the C-COMB3/C-ICOMB2 and R-COMB2/R-ICOMB1 pairs of signals are used as time markers to indicate a state transition to the other modem. In Annex C, TTR synchronization can be established as described above. Because these transitions occur at the hyperframe boundary, known to both modems, the C-COMB3/C-ICOMB2 and R-COMB2/R-ICOMB1 pairs of signals are not needed and can therefore be bypassed. This can reduce the Channel Discovery Phase, and thus the initialization time, by one or two hyperframes.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. For example, various configurations and modifications to the TTR indication signal can be made without departing from the inventive concepts described herein. It is therefore intended that the scope of the invention be limited not by this detailed description, but rather by the claims appended hereto.

We claim:

1. A method for synchronizing a TTR clock during a Channel Discovery Phase of a DSL service initialization operating in a TCM-ISDN noise environment, the method comprising:
transmitting a C-COMB signal to a customer premises DSL transceiver during the Channel Discovery Phase, the C-COMB signal including a TTR indication portion allowing the customer premises DSL transceiver to synchronize a TTR clock; and
during a quiet period of the Channel Discovery Phase, transmitting a TTR indication signal to the customer premises DSL transceiver to maintain synchronization of the transceiver's TTR clock.

2. The method of claim 1, wherein the TTR indication signal comprises at least one hyperframe that includes:
a first set of symbols for indicating the hyperframe boundary; and
a second set of symbols having no signal for allowing quiet noise measurement.

3. The method of claim 2, wherein the first set of symbols includes the first continuous group of symbols of the hyperframe dominated by far-end crosstalk interference.

4. The method of claim 3, wherein the TTR indication signal comprises a COMB or inverted COMB signal transmitted during each of the first set of symbols.

5. The method of claim 3, wherein the TTR indication signal comprises a REVERB signal transmitted during the first set of symbols.

6. The method of claim 5, wherein the REVERB signal includes a range of sub-carriers selected in a frequency range low enough to avoid being attenuated when transmitted to the customer premises DSL transceiver.

7. The method of claim 2, further comprising:
measuring at least one quiet noise parameter during the second set of symbols.

8. The method of claim 7, wherein the measured quiet noise parameter is quiet noise level per bin.

9. The method of claim 7, wherein the measuring at least one quiet noise parameter is performed for symbols in the presence of far-end crosstalk or near-end crosstalk.

10. A method for maintaining TTR synchronization in a customer premises DSL transceiver during a Channel Discovery Phase of a DSL service initialization operating in a TCM-ISDN noise environment, the method comprising:
receiving a TTR indication signal from a central office DSL transceiver, the TTR indication signal comprising at least one hyperframe that includes a plurality of symbols, some of which contain no signal from the central office DSL transceiver;
using at least a portion of the TTR indication signal to synchronize a local TTR clock thereto; and
measuring a quiet noise parameter during symbols of the hyperframe in which no signal is received from the central office DSL transceiver.

11. The method of claim 10, wherein the TTR indication signal comprises at least one hyperframe that includes:
a first set of symbols for indicating the hyperframe boundary; and
a second set of symbols having no signal for allowing quiet noise measurement.

12. The method of claim 11, wherein the first set of symbols includes the first continuous group of symbols of the hyperframe dominated by far-end crosstalk interference.

13. The method of claim 12, wherein the TTR indication signal comprises a COMB or inverted COMB signal transmitted during each of the first set of symbols.

14. The method of claim 12, wherein the TTR indication signal comprises a REVERB signal transmitted during the first set of symbols.

15. The method of claim 14, wherein the REVERB signal includes a range of sub-carriers selected in a frequency range low enough to avoid being attenuated when transmitted to the customer premises DSL transceiver.

16. The method of claim 11, further comprising:
measuring at least one quiet noise parameter during the second set of symbols.

17. The method of claim 16, wherein the measured quiet noise parameter is quiet noise level per bin.

18. The method of claim 16, wherein the measuring at least one quiet noise parameter is performed for symbols in the presence of far-end crosstalk or near-end crosstalk.

19. A central office DSL transceiver for maintaining synchronization of a customer premises TTR clock during a Channel Discovery Phase of a DSL service initialization operating in a TCM-ISDN noise environment, the transceiver configured to perform the operations:
transmitting a C-COMB signal to a customer premises DSL transceiver during the Channel Discovery Phase, the C-COMB signal including a TTR indication portion allowing the customer premises DSL transceiver to synchronize a TTR clock; and
during a quiet period of the Channel Discovery Phase, transmitting a TTR indication signal to the customer premises DSL transceiver to maintain synchronization of the transceiver's TTR clock.

20. The transceiver of claim 19, wherein the TTR indication signal comprises at least one hyperframe that includes:
a first set of symbols for indicating the hyperframe boundary; and
a second set of symbols having no signal for allowing quiet noise measurement.

21. The transceiver of claim 20 wherein the first set of symbols includes the first continuous group of symbols of the hyperframe dominated by far-end crosstalk interference.

22. The transceiver of claim 21, wherein the TTR indication signal comprises a COMB or inverted COMB signal transmitted during each of the first set of symbols.

23. The transceiver of claim 21, wherein the TTR indication signal comprises a REVERB signal transmitted during the first set of symbols.

24. The transceiver of claim 23, wherein the REVERB signal includes a range of sub-carriers selected in a frequency range low enough to avoid being attenuated when transmitted to the customer premises DSL transceiver.

25. The transceiver of claim 20, the transceiver further configured to perform the operation:
measuring at least one quiet noise parameter during the second set of symbols.

26. The transceiver of claim 25, wherein the measured quiet noise parameter is quiet noise level per bin.

27. The transceiver of claim 25, wherein the measuring at least one quiet noise parameter is performed for symbols in the presence of far-end crosstalk or near-end crosstalk.
